(19) United States
(12) Patent Application Publication
(10) Pub. No.: US 2014/0174265 A1
(43) Pub. Date: Jun. 26, 2014

(54) Holding Wrench with Torsion-Resistant Variable Engagement Mechanisms

(71) Applicant: Martin Thomas Wirth, Bailey, CO (US)

(72) Inventor: Martin Thomas Wirth, Bailey, CO (US)

(21) Appl. No.: 13/722,752

(22) Filed: Dec. 20, 2012

(51) Int. Cl. B25B 13/50

(52) U.S. Cl. CPC B25B 13/50
USPC 81/450; 81/124.5

(57) ABSTRACT

The holding wrench consists of a torsion-resistant lever with an extension for a pivot to hold a second torsion-resistant arm to present two mobile surfaces in a fixed work plane. The force of the present invention is applied parallel to the work plane resulting in a torque vector that is perpendicular to the work plane. The working ends of the lever and arm have emplacements for tooling such as rigid pins or holes to attach to protrusions such as bolt heads. Two male tooling emplacements each consist of hole in which tooling is inserted and a threaded hole located orthogonal to the tooling hole for a set screw or other fastener that may hold the tooling in place. Two female tooling emplacements may be used to directly engage protrusions on a sprocket or as receptacles for tooling custom fitted to said protrusions.

### TECHNICAL FIELD

The present invention relates generally to tools for working with pulley and sprocket assemblies on rotating shafts including, but not limited to, crankshafts and camshafts where the tool is designed to apply torque to rotate or hold the assembly stationary while assembly or disassembly operations requiring significant opposing torque are performed.

### BACKGROUND ART

The usual problem with assembling or disassembling rotating mechanisms is that fasteners such as nuts and bolts need enough torque that, when applied, tends to rotate the entire mechanism. This necessitates some means of holding the mechanism with sufficient opposing torque to perform assembly or disassembly operations on said fasteners or other items.

Prior art describes a variety of tools used to hold pulleys and sprockets to facilitate the assembly and disassembly of rotating automotive components. U.S. Pat. No. 6,978,703 issued on Dec. 27, 2005 to Michael L. Whitehead and Donald R. Simmons describes a Cam Gear Holding and Turning Wrench. This wrench includes first and second arms which are slidably attached to each other to provide adjustable spacing between transverse rods that are used to engage a cam gear. Nuts and bolts holding the arms together are used to fix the spacing between the transverse rods to attach the wrench to a variety of cam gears. The cam gears must have at least two openings in which the transverse rods may be inserted.

U.S. Pat. No. 6,343,529 issued on Feb. 5, 2002 to James L. Pool describes a Fan Clutch Wrench Kit composed of two separate tools. The holding wrench consists of a fixture to which a pair of arms is attached. Each arm is attached to the fixture by a pivot and a slot. Each slot is angled so the spacing between the ends of the arms that attach to the fan clutch may be adjusted by turning a screw on the fixture. The head of the screw is located so that the adjustment may be easily made while the tool is positioned on the fan clutch which enables the mechanic to tighten the wrench onto bolt heads protruding from the clutch housing. This feature would reduce the tendency of the tool to slip off the clutch while turning the nut which holds the fan clutch on the crankshaft.

U.S. Pat. No. 2,454,489 issued on Nov. 23, 1948 to Jerry J. Sullivan describes a Spanner Wrench with Means to Grip the Inner Surface of Pulley Rims. This holding wrench consists of a pair of levers, one which applies torque to rotate or hold the pulley and the other to pull a hooking arm against the rim with sufficient force to use the friction between the tool and the inside of the pulley rim to hold the pulley. This wrench is especially useful on sprockets that have neither holes nor protrusions for other types of holding wrenches.

U.S. Pat. No. 7,114,417 issued on Oct. 3, 2006 to Tom Dring describes an Adjustable Spanner Wrench for Spanner Heads Having Different Size Holes. The utility of this wrench is directed towards spanner head machine screws and nuts that utilize a spanner wrench. It consists of two symmetrical arms each of which is thickened to provide storage space for various sizes of engageable pins.

### SUMMARY OF INVENTION

### Technical Problem

Most tools used to hold rotatable components and assemblies are designed to hold a very limited set of items. Some of the commonly used tools are likely to damage working surfaces of pulleys, sprockets, and gears even with proper usage. Some tools currently in use may also spring loose as more opposing torque is applied to the work piece which delays progress on the work, and creates an annoyance and hazard for the mechanic. Other holding tools are structurally flexible and store energy as torque is applied to fasteners on the work piece. When breaking loose bolts that have been torqued by normal transfer of power through an existing assembly, structural flexibility in existing tools stores energy. When the bolt breaks loose, this energy may recoil against the hand of the mechanic causing pain and possible injuries.

### Solution to Problem

An objective of the present invention is to provide a wrench with exceptional rigidity where it is needed with adjustability to handle a wide variety of pulleys, sprockets, gears, and other rotatable components and assemblies.

Another objective of the present invention is to provide a wrench for holding or turning rotatable components or assemblies where the rigidity and configuration of the wrench provides ease, comfort, and improved safety to the mechanic.

Another objective of the present invention is to provide a wrench that can be manufactured economically.

### BRIEF DESCRIPTION OF DRAWINGS

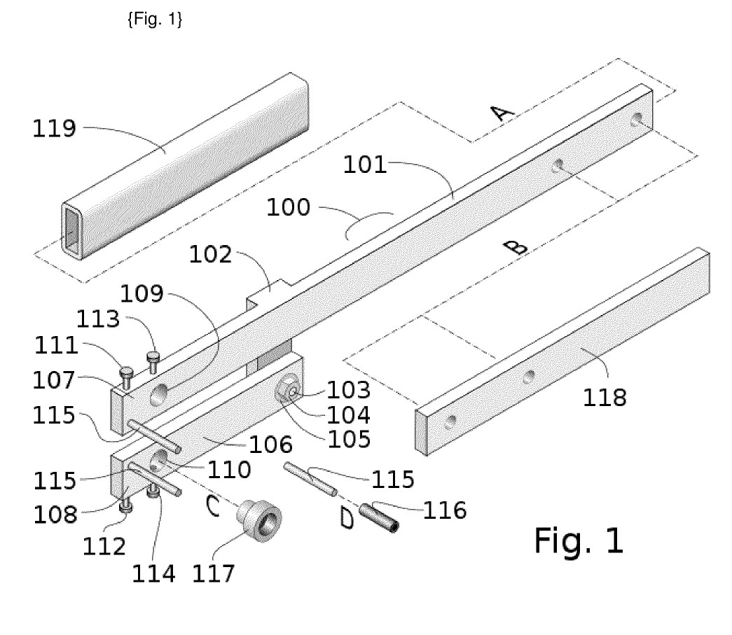

{FIG. 1} is a perspective view of the present invention showing the side that would face the work piece along with accessories and their attachment pathways.

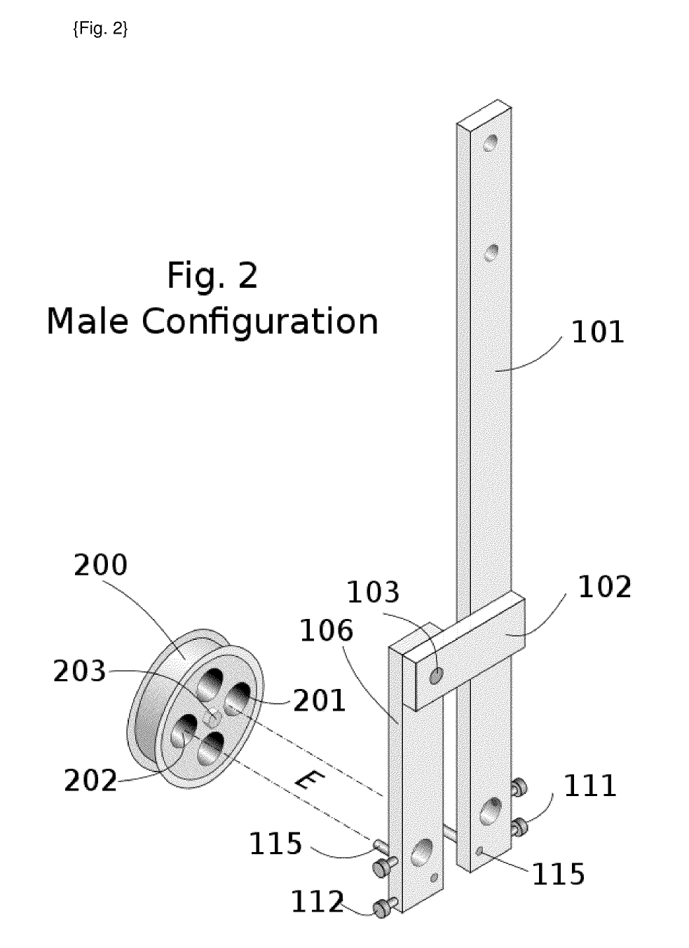

{FIG. 2} is a perspective view of the present invention showing a male configuration facing towards a work piece having openings to be engaged for holding the work piece.

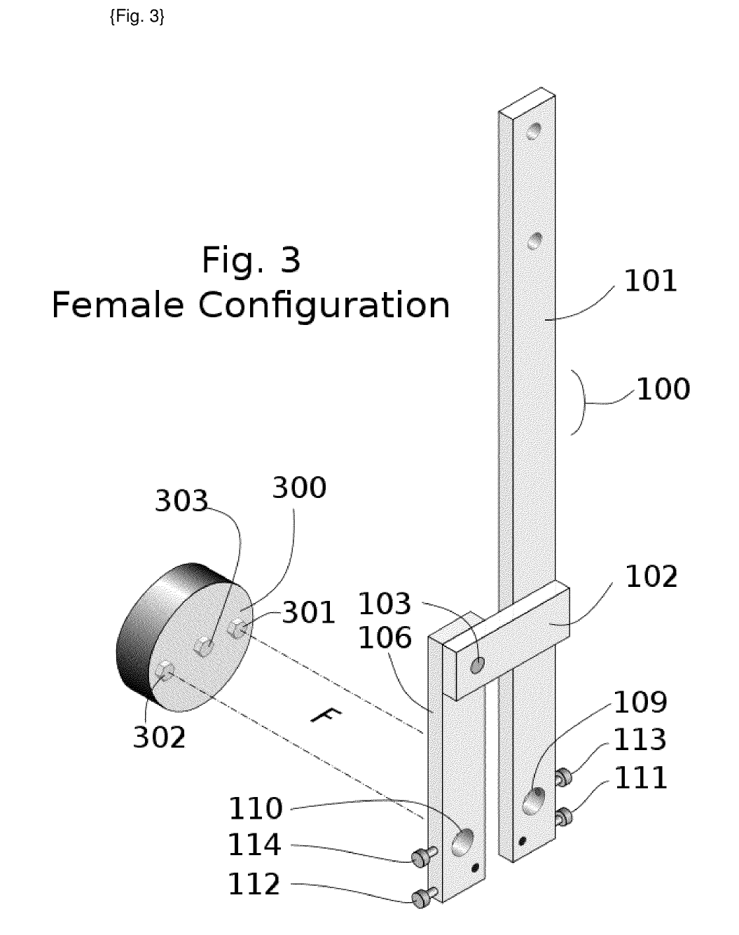

{FIG. 3} is a perspective view of the present invention showing a female configuration facing towards a work piece having protrusions to be engaged for holding the work piece.

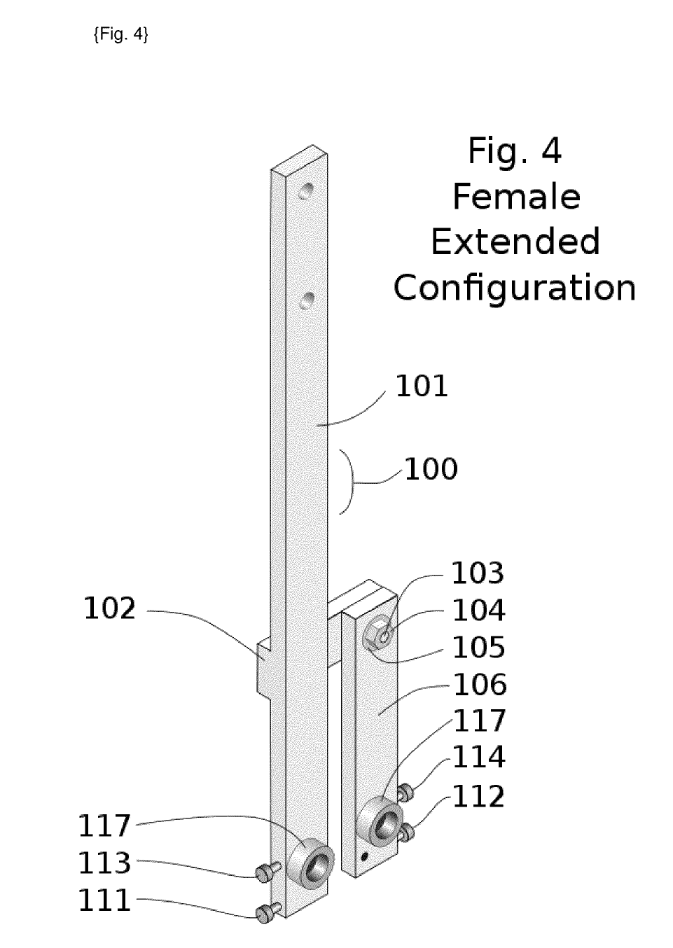

{FIG. 4} is a perspective view of the present invention showing a female extended configuration for engaging work pieces that have protrusions that require customized tooling to engage or where protrusions are recessed within the work piece.

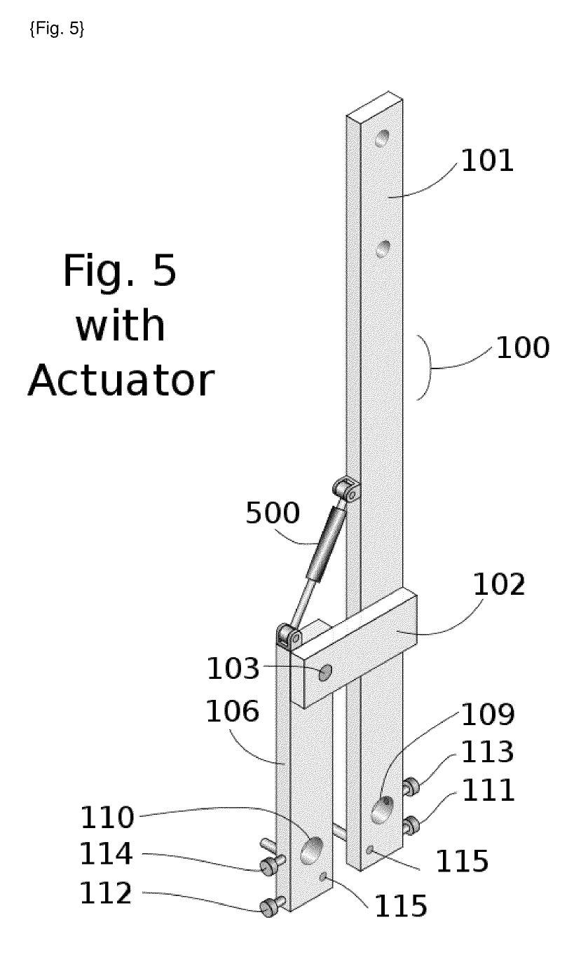

{FIG. 5} is a perspective view of the present invention showing an actuator that may be used to adjust the spacing between the tooling emplacements.

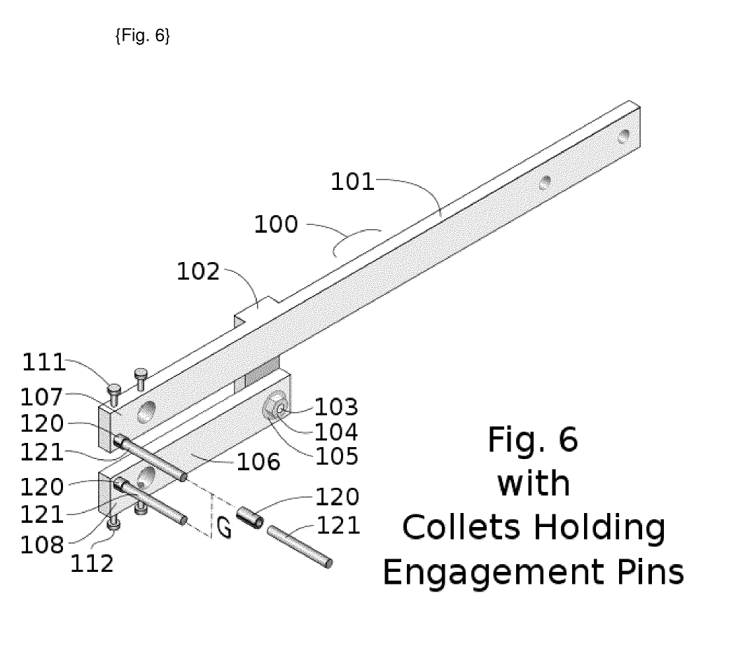

{FIG. 6} is a perspective view of the present invention showing engagement pins mounted with collets.

### REFERENCE NUMERALS USED IN THE DRAWINGS

100 holding wrench
101 lever
102 pivot extension
103 pivot
104 arm retention nut
105 arm retention washer
106 arm
107 lever tooling emplacement
108 arm tooling emplacement
109 lever female engagement hole or tooling emplacement
110 arm female engagement hole or tooling emplacement
111 lever male tooling set screw
112 arm male tooling set screw
113 lever female tooling set screw
114 arm male tooling set screw
115 engagement pin
116 engagement bushing
117 female extension tooling
118 bolt-on lever extension
119 tubular lever extension
120 engagement pin support collet
121 engagement pin supported by collet
200 rotatable work piece with engagement holes
201 engagement hole (as an aim of lever tooling)
202 engagement hole (as an aim of arm tooling)
203 bolt or nut holding rotatable work piece to shaft or other assembly
300 rotatable work piece with engagement protrusions
301 engagement protrusion (as an aim of lever tooling)
302 engagement protrusion (as an aim of arm tooling)
500 actuator for automated applications

### DESCRIPTION OF EMBODIMENTS

In {FIG. 1}, {FIG. 2}, {FIG. 3}, {FIG. 4}, {FIG. 5}, and {FIG. 6} the invention 100, hereinafter called the wrench, is composed of a lever 101 with a permanently attached offset 102 and fixed pivot 103 upon which a rotatable arm 106 is attached and retained by a nut 104 or other adjustable fastener bearing against a washer or surface 105. Both the lever 101 and the arm 106 have emplacements on the ends for both male 107, 108 and female 109, 110 tooling. Tooling may be comprised of hardened pins 115 that may also be covered with bushings 116 made of softer material to protect the finish of the work piece as assembled along path D in {FIG. 1}. Female tooling may consist of extensions 117 assembled into the wrench along path C in {FIG. 1} for reaching protrusions inside of recessed work pieces, or the female emplacements 109, 110 may be used to directly engage readily accessible protrusions. Both male 115 and female 117 tooling may be held in place by tightening set screws for the male 111, 112 and female 113, 114 respectively. The leverage of the wrench may be extended by the use of an extension tube 119 assembled along path A or by an extension bar 118 that may be bolted on after assembling along path B.

In {FIG. 2} the embodiment 100 is shown with male tooling pins 115 inserted into emplacements 107, 108 and held by set screws 111, 112 which, when facing a work piece 200 with two or more holes 201, 202 may be moved into the rotatable work piece along path E to hold it in place or rotate it. Once so affixed in the work piece, the nut or bolt 203 may be torqued to assemble or disassemble the work piece onto a shaft or other rotatable component.

The embodiment 100 as shown in {FIG. 3} may also have the male tooling detached and set aside to hold a rotatable work piece 300 that has two or more protrusions 301, 302 such as bolt heads instead of holes by attaching the wrench along path F in {FIG. 3}. In the case of female tooling, the holes 109, 110 in which specialized female tooling may be emplaced could themselves be used in lieu of any additional tooling to engage protrusions on the work piece. When the protrusions have been engaged, a socket wrench may then be used to tighten or loosen the nut or bolt 303 holding the work piece to a shaft or rotatable assembly.

The embodiment 100 as shown in {FIG. 4} has the female extension tooling 117 attached. Set screws 113, 114 are tightened down to hold the female extension tooling in place.

The embodiment as shown in {FIG. 5} has an actuator 500 that adjusts the spacing between the tooling emplacements. This embodiment would be used in automated applications where it is itself mounted on a positioning actuator that would engage the work piece on an assembly line. The actuator 500 in this embodiment would consist of a mechanism that may change length such as a screw and nut assembly driven by a stepper motor or a hydraulic cylinder.

The embodiment with the actuator shown in {FIG. 5} may also be used in a manual application where the length of the actuator would be manually set to fix the spacing between the tooling emplacements. The actuator in this embodiment would consist of a mechanism such as a screw and nut assembly where either the screw or the nut would be retained and manually turned to adjust the spacing of the tooling emplacements. This embodiment would be preferred by a mechanic whose task would be to assemble or disassemble a number of work pieces having the same hole or protrusion dimensions.

The embodiment as shown in {FIG. 6} may accept various sizes of engagement pins 121 held by collets 120 as shown assembled along path G. The outside diameter of each collet 120 would be the same while the inside diameters would vary to accept engagement pins 121 of different diameters. This embodiment would be preferred by a mechanic where engagement holes in the pulley are a smaller diameter than the engagement pins 115 in {FIG. 1} that fit in the male tooling emplacement without the collet or it would enable a wrench designed to accept larger engagement pins for jobs requiring a longer reach or more torque.

1. A tool, hereinafter called the wrench, for holding a rotatable work piece such as a pulley or sprocket to facilitate the attachment, tightening, or removal of fasteners such as nuts and bolts that hold a work piece on a shaft, said tool comprising a torsion-resistant lever, an offset pivot affixed to the lever, and a torsion-resistant arm attached to the pivot, both working ends of the lever and arm having emplacements for tooling such as rigid pins that may be inserted into two holes and leaving sufficient room in the center for receiving a driver that attaches to and applies torque to the shaft bolt or other fasteners.

2. The wrench according to claim 1, wherein pins or other male tooling shall be inserted into the emplacement holes on the working ends of the lever and arm to be held in place by set screws or other fasteners to be used to engage holes or concavities in a rotatable work piece.

3. The wrench according to claim 1, wherein holes located on the working ends of the arm and lever shall be used to engage protrusions on a rotatable work piece.

4. The wrench according to claim 1, wherein holes located on the working ends of the arm and lever shall emplace female tooling that would be used to engage protrusions on a rotatable work piece.

5. The wrench according to claim 4 where the female tooling shall be made in a variety of practical dimensions.

6. The wrench according to claim 1 wherein the lever and pivot extension is made from steel or other high-strength alloy that may be composed of materials welded together, cast as a single piece, or injection molded from high strength plastic.

7. The wrench according to claim 1 wherein the arm is made from steel or other high-strength alloy that may be composed of a machined bar, cast as a single piece or injection molded from high-strength plastic.

8. The wrench according to claim 1 wherein the tooling, collets, or engagement pins on the working ends are made of tool steel or other high-strength alloys.

9. The wrench according to claims 3 and 4 wherein the wrench may be composed of high-strength plastic and the tooling holes are surfaced by hardened inserts that have been injection-molded in place or otherwise inserted into the softer material to provide stronger emplacement surfaces for the engagement tooling.

10. The wrench according to claims 1 where the engagement pins may be surfaced with a bushing made of bronze or other material softer than that from which the sprocket is made to prevent marring or scratching the sprocket.

11. The wrench according to claim 10 where the bushing may be held in on the engagement pin with a small set screw tightened through a hole that has been tapped into the bushing.

12. The wrench according to claim 10 where the bushing may be held in place by a set collar.

13. The wrench according to claim 1 where female extension tooling may be inserted into the female tooling emplacements.

14. The wrench according to claims 4 and 5 wherein the arm is connected to the pivot by an additional actuator such as a stepper assembly or hydraulic cylinder.

15. The wrench according to claim 12 wherein the actuator is connected in series with one or more preloaded springs.

16. The wrench according to claim 1 wherein additional torque may be applied by extending the lever with a tube fitted over said lever.

17. The wrench according to claim 1 wherein the wrench is mounted on a robotic arm or positioning actuator.

18. The wrench according to claim 1 wherein the engagement pins may be mounted inside a collet to enable the use of more than one diameter of engagement pin.
